(19) United States
(12) Patent Application Publication
(10) Pub. No.: US 2001/0013060 A1
(43) Pub. Date: Aug. 9, 2001

(54) Method for trading data in a network

(76) Inventor: Reiner Hutwelker, Munchen (DE)

Correspondence Address: Thomas R. FitzGerald, Esq., JAECKLE FLEISCHMANN & MUGEL, LLP, 39 State Street, Rochester, NY, 14614-1310, US

(21) Appl. No.: 09/748,628

(22) Filed: Dec. 22, 2000

(30) Foreign Application Priority Data
Dec. 23, 1999 (DE) 199 62522.0

(51) Int. Cl. G06F 15/16; G06G 7/00; G06F 17/00

(52) U.S. Cl. 709/217; 709/205; 709/219; 705/400

(57) ABSTRACT

If it is intended that data in a network, e.g. the Internet, are not available freely and free of charge for a user accessing the data, then the access to data will be granted only if a monetary payment specified depending on the data is executed prior to, during, or after the data access. Contrary to that, the invention enables accessing the data of other users of a network in that the accessing user provides own data in the network as a consideration. When a user provides data in the network, the data and the user are assigned a number of points. In order to be able to access data of other users, the accessing user has to redeem the number of points assigned to him/her which corresponds to the number of points assigned to the desired data. For taking into consideration the different benefit of data in the network, the user who has accessed the data has to rate the data in that he/she assigns a number of points in a predetermined value range. From this number of points predetermined by the accessing user and the number of points which have previously been assigned to the data, an adjusted number of points for the data is determined. Upon another access to the data, a number of points is to be redeemed which corresponds to the adjusted number of points for the data. In this way, it is possible to trade data in a network without the necessity of executing monetary payments. In addition, the invention enables the trading of data in a manner which is comparable with the trading of stocks.

### CROSS-REFERENCE TO RELATED APPLICATIONS

This application claims priority of German Patent Application 199 62522.0, filed Dec. 23, 1999.

### DESCRIPTION

1. Background of the Invention

The present invention relates to data transmissions in a network. In particular, the present invention relates to trading data in a network, with the data being accessible in the network if an accessing user has also made their own data available for access via the network.

2. State of the Art

Data transmissions in a network can generally be classified into two types. On the one hand, there are data which are freely available and free of charge for a user accessing the data. This means that upon an access to such data no consideration, e.g. in the form of a monetary payment, is to be executed. On the other hand, there are data, for example data from information databases or service providers, as well as computer programs, e.g. computer game programs and the like, which may be accessed only if an accessing user executes a monetary payment prior to, during, or after an access. This can be done, for example, by debiting the monetary payment from an account which is associated e.g. with a credit card of the user, or via a detailed statement which is prepared in conjunction with a telephone service.

The approach of executing a monetary consideration upon the access to data in a network brings with it several drawbacks. Suitable devices and methods are necessary which enable the execution of the monetary consideration and, in addition, must ensure that the required security is ensured for the execution of the monetary consideration in order to prevent any abuse. Moreover, this approach restricts the circle of users of the network who access the data to be paid for, because many users are interested in such data but are not willing to make a monetary payment for them. In addition, users of the network who provide data in the network are prevented from combining the access to the data with the execution of a monetary payment, because on the basis of the above mentioned reasons they assume that only a few users are willing to execute a monetary payment for the access to the data.

### OBJECT OF THE INVENTION

The present invention is based on the object to eliminate the previously mentioned drawbacks of the state of the art. In particular, the invention is to enable that, on the one hand, data in a network cannot be accessed freely and free of charge for a user accessing the data, with no monetary payment to be executed for the access, on the other hand. In addition, the utilization of the invention is intended to increase the quantity of data which are available in a network as well as the number of users of these data.

### INVENTIVE SOLUTION

For the solution of this object, the invention provides a method according to claim 1 as well as a data carrier according to claim 17, and a system according to claim 19.

In the method according to the invention for trading data in a network, data which can be accessed in the network are assigned each a first predetermined number of points. This first number of predetermined points corresponds to the initial current number of points for the various data, with the current number of points specifying the value of the data (i.e., the point value). In order to be able to access the desired data in the network, the data which are to be accessed are assigned a further number of points which corresponds to the current number of points for the data. Subsequently, the data can be accessed. For the purpose of considering the various information contents of the data, and their benefits for an accessing user, respectively, the current number of points for the data being accessed is adjusted, for example, increased, by a number of points which is codetermined by a user of the network who accesses the data.

In this manner it becomes possible that data in a network can neither be accessed freely and “free of charge” for a user accessing the data, nor any monetary payment becomes due for an access. According to the invention, the execution of a monetary payment is substituted by the assignment of the further number of points which corresponds to the current number of points for data which are to be accessed. In addition, the “market value” of the data in the network is taken into account by increasing the current number of points of data, which is codetermined by a user accessing the data. In this context it is possible to have the number of points by which the current number of points for data is increased determined by the user either indirectly or directly.

### ADVANTAGEOUS EMBODIMENTS OF THE INVENTION

For the purpose of increasing the volume of data which can be accessed in the network as well as offering the users of the network the possibility to provide their own data in the network, the method according to the invention comprises a provision of data which can be accessed in the network, with a first computer system being utilized.

In addition, the assignment of the further number of points which corresponds to the current number of points of the data which are to be accessed, and/or the access to the data can be carried out by a second computer system.

In order to be able to assign a corresponding further number of points by using the first computer system for later accesses the assignment of the first predetermined number of points can comprise an assignment of a number of points to the first computer system, which corresponds to the first predetermined number of points.

For the same reason and in order to “compensate” the user of the first computer system for the provision of data, the assignment of the current number of points for to the data can comprise an assignment of a number of points to the first computer system, which corresponds to the current number of points for the data.

In order to be able to associate the execution of the consideration for the access to data in the form of assigning the further number of points to the accessing computer system and its user, respectively, the assignment of the further number of points corresponding to the current number of points should be carried out by the second computer system in such a manner that points are used for this purpose which are assigned to the second computer system.

Furthermore, it is to be preferred that the number of points by which the current number of points of data is to be increased is specified by the user depending on the information contents and/or the benefit of the data which have been accessed by the user.

The types of data which can be accessed in the network are not restricted to certain types of data. For example, data can be used which are text, graphic, audio, video and/or multimedia data. Alternatively or additionally, the contents provided can also include computer software programs.

In order to facilitate the access to data in the network, information data can be made available to the accessing computer system and its user, respectively, which serve to select data which can be accessed.

In particular, information data can be provided which indicate the content and/or the current number of points of the data which can be accessed.

A further facilitation of the data access is made possible if query data are provided which serve to select data which a user wants to access. These query data are then compared with the data available in the network or at least with parts of the same, and data for which the comparison has resulted in at least a partial match, and/or data which indicate the data found during the comparison will be provided. Preferably, the query data are provided by means of the second computer system.

In order to prevent an accessing computer system and its user, respectively, from overdrawing the corresponding “point account”, i.e. from assigning more points for accessing data to the same, the assignment of the further number of points which corresponds to the current number of points of the data which are to be accessed should be possible only if the second computer system has been assigned at least a number of points which corresponds to the current number of points of the data.

Due to the fact that the determination of points by which the current number of points of the data is increased is effected after accessing the data, it is possible that the user does not determine such a number of points. The number of points which is assigned to the second computer system is reduced by a second predetermined number of points upon an access to data so that the current number of points of data truly reflects the current “market value” of the data. When the user has determined the number of points which is required for the increase of the current number of points, the number of points which is assigned to the second computer system will be increased by the second predetermined number of points upon the increase of the current number of points of the data.

In order to prevent an overdrawing of the “point account” of the second computer system upon the decrease of the number of points which is assigned to the second computer system, an access should be possible only if the number of points which are assigned to the second computer system corresponds at least to the sum of the current number of points of the data which are to be accessed and the second predetermined number of points.

Furthermore, the invention provides a data carrier which includes data for executing the method according to the invention. Preferably, the data carrier includes data which preferably comprise one software program.

Moreover, the invention contemplates a system for trading data in a network, which comprises a central computer system as well as at least one computer system and a network connecting the same. In particular, the central computer system and/or the at least one computer system are designed in such a manner that they carry out the method according to the invention.

### BRIEF DESCRIPTION OF THE FIGURES

FIG. 1 is a schematic illustration of a network for carrying out an embodiment of the method according to the invention.

FIG. 2 is a graph of the course of the value of data, the ratings for the data at each data access, as well as the account balance of the user providing the data after each access in the trading of data according to the invention.

FIG. 3 is a schematic illustration of further system for carrying out another embodiment of the invention.

### DESCRIPTION OF PREFERRED EMBODIMENTS

In the following description the term “data” is to be understood as any type of information which can be reproduced in the form of data. Data in terms of the invention can both be digital and analog data. Examples for this are text, audio, video, graphic, and multimedia data, analog and digital measuring signals, analysis results, computer and video game software, information on stock quotations and exchange rates, as well as data from knowledge and information databases and lexical databases, and the like.

The term “network” as used in conjunction with the invention covers all types of networks which are suitable for transmitting the above mentioned data. Examples for this are the Internet, terrestrial telephone networks, mobile telephone networks, networks for transmitting radio and/or television programs, local and in-house computer networks, and the like.

Accordingly, the term “computer system” covers all devices which are able to transmit (i.e. send and/or receive) and/or process above mentioned data by utilizing networks of the above mentioned type. In addition to computers, network computers, high-capacity computer systems, etc., this also includes devices which are able to at least partially transmit and/or process analog and/or digital data, for example, (de)(en)coding devices for radio and/or television information (e.g. set top boxes) as well as stationary and mobile telephones.

Furthermore, the terms “points” and “account” will be used in the following. On the one hand, points are to be understood as a measure for the value of data and, on the other hand, as payment means for paying for utilized/desired data. Points in terms of payment means are not monetary considerations, they can, however, be compared with same. In order to be able to utilize data of a certain value, i.e. with a certain number of assigned points, the corresponding number of points must be paid. Points will be stored in so-called accounts and can be transferred to accounts and withdrawn from the same and set off against data. In this context, accounts are to be understood as devices, components, or areas of the above mentioned computer systems into which data/information can be read, in which data/information can be stored and from which data/information can be output which specify a number of points. In the simplest case, an account is a storage area of a computer memory, or a device with a processor using a memory. However, it is also possible to use analog memory units as accounts.

These above explained terms will be used in the following description of preferred embodiments of the invention without further explanations.

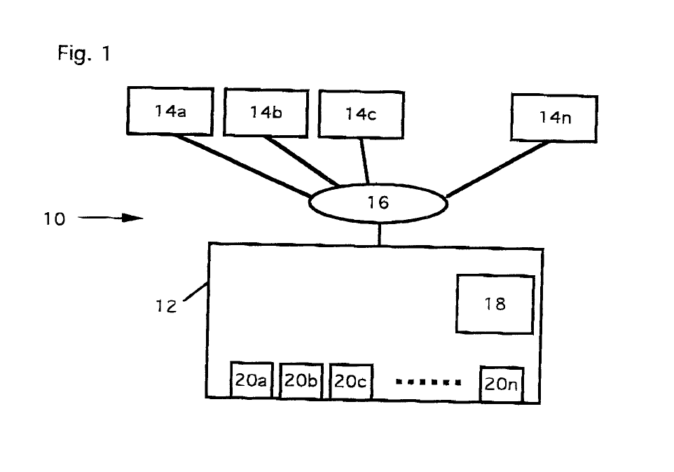

FIG. 1 shows a schematic illustration of a system for carrying out an embodiment of the method according to the invention. The system 10 comprises a central computer system 12, several computer systems 14a, . . . , 14n, and a network 16. The computer systems 14a, . . . , 14n and the central computer system 12 are connected with each other via the network 16.

The central computer system 12 serves to control the data communication between the computer systems 14a, . . . , 14n, as well as to control the access to data by the computer systems 14a, . . . , 14n. In a storage area 18 of the central computer system 12, the data available for trading as well as respective information associated with the individual data are stored. Further, the central computer system 12 comprises storage areas 20a, . . . , 20n which serve as accounts. Each computer system 14a, . . . , 14n which is connected with the central computer system 12 for trading data is assigned a corresponding account 20a, . . . , 20n.

Essentially, the method for trading data in a network is based on the fact that a user of a computer system 14a, . . . , 14n is himself/herself also providing data which can be accessed. For this purpose, for example the user of the computer system 14a receives a predetermined number of points, e.g. five points, which he/she is credited to a corresponding account 20a. This number of points credited/assigned to the user serves as a payment means in trading data. Further, the data provided by the user are assigned the same number of points (i.e., the point value) which corresponds to the number of points in the account 20a of the user providing the data. This number of points assigned to the data (i.e., the point value), e.g. five points, represents the value of the data at the time of their provision.

In the simplest case, all data are rated with the same number of points (point value) upon their input into the system 10. Thus, all data have the same initial point value, and all users are credited the same number of points to the corresponding accounts 20a, . . . , 20n upon submitting the data. Alternatively or additionally, it is possible that the data are initially rated or valued differently. For this purpose the data can, for example, be divided into various categories, with data of one category being assigned the same initial value, while data of other categories may initially be rated differently. The data can, for example, be categorized as data comprising only text data, combined text and graphic data, video data, or other data types and combinations of data types, respectively. Furthermore, it is also possible to classify the data according to their information content. For example, a distinction can be made between data with scientific information, economic data, and data of general interest.

In order to be able to access data provided in the system 10, a user of one of the computer systems 14a, . . . , 14n selects individual or several desired data. For this purpose the user is provided with corresponding information by the central computer system 12, which specifies the available data and/or their contents. When the user has selected individual or several data which he/she wants to access, he/she informs the central computer system 12 accordingly which will debit the number of points corresponding to the point value of the desired data from a corresponding one of the accounts 20a, . . . , 20n. If, for example, the user wants to access a document with a point value of five or several documents with a total point value of twenty, then five or twenty points, respectively, will be debited from a corresponding one of the accounts 20a, . . . , 20n. Only then when the data have been “paid for” in this manner, the access to the desired data will be enabled. In response, the user(s) who has (have) provided the data which have been accessed will be credited the number of points to his/her (their) account(s), which corresponds to the point value of the utilized data and which were debited from the account(s) of the accessing user(s).

On the one hand, the account balance of points can be increased by providing new data. On the other hand, the account balance of points is increased if the data are accessed which are associated with the account. Because it cannot be ensured that a user provides new data or that data provided by a user are accessed, the accounts 20a, . . . , 20n cannot be “overdrawn”, i.e. it is not possible to deduct more points from the account for the access to data than are available in the account.

Further, it has to be assumed that the provided data comprise information of different quality levels. For example, data can include simple graphics while other data include scientific texts or economic information. In order to take these differences into consideration and to design trading data in a manner which can be compared to trading conventional goods, each user of data of the system 10 has to rate the same, after accessing the data. For this purpose, the user has to evaluate the obtained data with respect to their benefit and/or information content and to rate this value of the data as evaluated by him/her with a number of points from a predetermined point range. A point range of, for example, 1 to 10 can be specified, with data of high information content and/or benefit for a user being rated with a high number of points, e.g. ten points, and data with a low information content and/or benefit for a user being rated with a small number of points, e.g. one point.

The number of points specified by the user in the rating of data is supplied to the central computer system 12, and this determines a new/adjusted point value for the data on the basis of the number of points specified by the user in his rating and the number of points assigned to the data prior to an access, which reflects the previous point value of the data. For this purpose, the arithmetic mean value of the user specified number of points and the number of points prior to an access is formed in the simplest case. However, it is also possible to form the root mean square value or employ other methods which interrelate the two point quantities, for this purpose. The new number of points determined in one these manners is assigned to the data as a new/adjusted point value or current value. Consequently, the number of points which corresponds to the new value of the data will be debited from the account of a user who wants to access newly rated data.

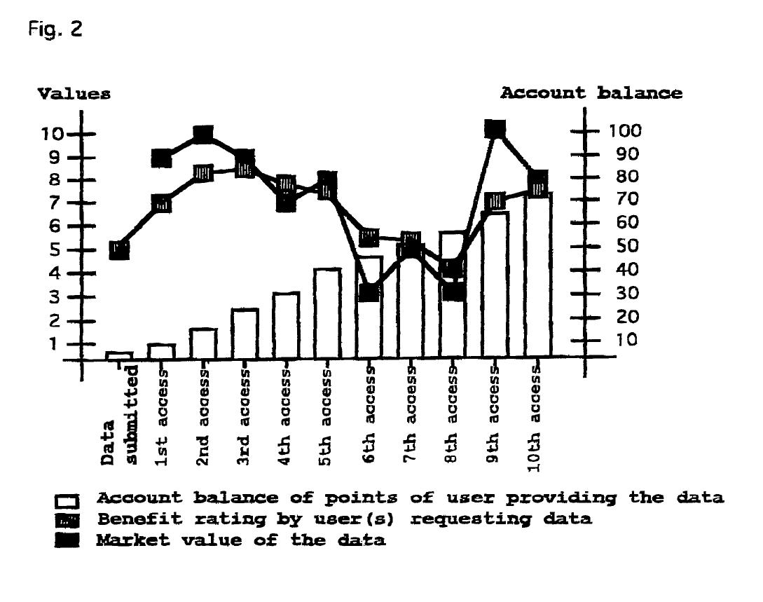

By the rating of data which is effected upon each data access the “value” or “market price” of the data changes after each access. An example of the course of the market price of data, the ratings of the data made by one or several users, as well as the “account balance” of the user providing the data, i.e. the number of points in his/her account, is shown in FIG. 2.

The determination of the market price of data under utilizing mean value generating methods from the current data value and the rating of the user accessing the data causes the market prices, as can be seen in FIG. 2, to be in the specified point range for the data rating. In order to obtain market prices beyond the specified point range for the data rating, market prices can be determined, additionally or alternatively, under utilizing methods which sum, multiply, and/or weigh the current data value and the rating of the user accessing the data in an interrelated manner.

Further, the market prices of data can be determined by taking into account the number of data accesses in a predetermined time interval, e.g. one day, one month, or one year. If, for example, data are accessed very frequently during one day, e.g. 1000 times per day, bottlenecks, e.g. in the form of time delays for and/or during data accesses, can result, depending on the data, the used computer systems 12, 14a, . . . , 14n, and/or the network 16. In order to take into consideration the interest for data, i.e. the demand for them, the market price of the data should therefore also be determined as a function of the access frequency. For this purpose, data for which there is a high demand, i.e. frequent accesses, should then have increasing market prices, while in the determination of the market prices of data less demanded the access frequency can be disregarded, or the consideration of the access frequency can result in decreasing market prices. The consideration of access frequencies to data can also lead to market prices which are beyond the specified point range for the data rating.

In order to ensure that each user reliably rates the data which he/she has accessed, a predetermined number of points (i.e., rating points) is debited from his/her account as pledge upon accessing data. Furthermore, a time can be specified for the users in which a rating of the data is to be made. With such a time specification it must, however, be taken into consideration that the rating of complex data can take a longer period of time than the rating of data with a small information extent. As soon as a user has rated the data utilized by him/her, i.e. assigned a certain number of points, and has made this rating available to the central computer system 12, the number of points which has been retained as pledge (i.e., the rating points) will be returned to his/her account. Alternatively or—in certain cases—additionally, it is, however, also possible for a user to overdraw his/her account upon the deposition of this pledge. This allows, for example, users who provide data in the network for the first time or who have provided data only once to access other data and both to pay the corresponding number of points as well as to deposit a pledge.

For the above mentioned reasons it should also not be possible to overdraw an account for debiting a number of points as pledge. Consequently, a user can access data only if his/her account holds at least the number of points which corresponds to the sum of the number of points corresponding to the value of the desired data and the number of points which is required for depositing the pledge.

In this manner it is possible to access data without executing any monetary payment. Further, the new rating of the data after each access results in the data becoming commercial goods with market-dependent values. In order to obtain information about data available in the network 16, the central computer system 12 should provide the accessing users with corresponding information (search engines, catalog-type information, . . . ).

In the previously described embodiment of the invention data which can be accessed in the system 10, and the accounts 20a, . . . , 20n are stored and managed by the central computer system 12. In order to reduce the amount of data which has to be communicated via the network 16 it can also be possible to have the data stored and managed by the individual computer systems 14a, . . . , 14n. In this case, the central computer system 12 takes over the control and the granting of access authorizations for data available in the individual computer systems 14a, . . . , 14n. In this context, it is for example possible that a user with access authorization, i.e. a user who has paid the required number of points for accessing data, receives a corresponding code (e.g. software code, (de)(en)coding software) from the central computer system 12 and is able to access data in other computer systems by means of this code.

Further, it is also possible to store the accounts 20a, . . . , 20n in the individual computer systems 14a, . . . , 14n, wherein the actual management of the accounts 20a, . . . , 20n should be effected by the central computer system 12 in order to avoid undesired manipulations of the accounts 20a, . . . , 20n. In this case, too, codes provided by the central computer system 12 can be used.

The essential task of the central computer system 12 is to manage the accounts 20a, . . . , 20n, and to control the access to these data, i.e. to grant or deny access authorizations. It is therefore not necessary that the actual access of data, i.e. their communication to a requesting computer system, is effected via the network 16 via which the individual computer systems 14a, . . . , 14n are connected with the central computer system 12.

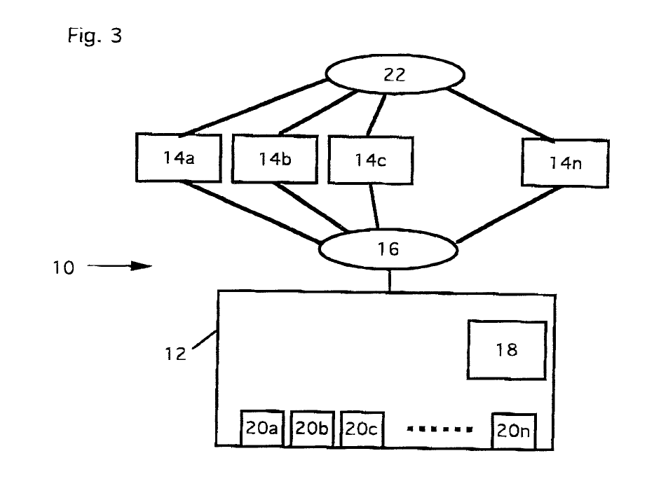

FIG. 3 shows a system for carrying out another embodiment of the method according to the invention, which takes the previously mentioned aspects into consideration. As illustrated in this figure, the system 10 here comprises a further network 22 which connects the individual computer systems 14a, . . . , 14n with each other, beside the network 16 which connects the computer systems 14a, . . . , 14n and 12. This network 22 primarily serves to communicate desired data to a requesting computer system, while the network 16 serves to communicate data between the individual computer systems 14a, . . . , 14n and the central computer system 12, which are required for the management of the accounts and the control of the data communications (distribution of access authorizations). The network 16 can, for example, be the Internet, while the network 22 can be a telephone network, a network for transmitting radio or television information, or any other network, which is suitable for the communication of data, or vice versa.

When a user, for example, has selected data which he/she wants to access on the basis of information provided by the central computer system 12, and transferred a corresponding number of points from his account, the central computer system 12 gives the requesting computer system and the user of the same, respectively, access authorization for the desired data. With this access authorization, e.g. an electronic code or encoding program, the requesting user can order the desired data via the network 22. The computer system which provides the desired data sends the desired data to the requesting computer system. Alternatively, this data communication to the requesting computer system can also be effected without a request via the network 22 if the central computer system 12 has transmitted corresponding information or a corresponding control command to the computer system which comprises the desired data.

1. A method for trading data in a network, said method comprising the steps of:
provision of data by a providing network user, the data being accessible via the network;
crediting a first number of points to the providing network user, said first number of points being dependent at least in part upon the provided data;
assigning a point value to the data, said point value corresponding to said first number of points;
access of the data by an accessing network user; and
adjusting said point value.

2. The method according to claim 1, wherein said provision of data step comprises a first computer system that is accessible via the network, said first computer system storing the data.

3. The method according to claim 2, wherein said crediting step comprises crediting said first number of points to said first computer system.

4. The method according to claim 3, wherein at least one of said assigning step and said access step is performed by a second computer system.

5. The method according to claim 4, said second computer having a second number of points, wherein said access step comprises:
comparing said point value of the data to be accessed to said second number of points;
denying access to the data when said second number of points is less than the point value of the data to be accessed; and
granting access to the data when said second number of points is at least equal to the point value of the data to be accessed.

6. The method according to claim 5, wherein said access step further comprises:
reducing the second number of points of the second computer by an amount that corresponds to said point value when the data is accessed.

7. The method according to claim 5, wherein said access step further comprises:
increasing said first number of points credited to the first computer system by an amount that corresponds to said point value when the data is accessed.

8. The method according to claim 5, wherein said adjusting said point value step comprises:
rating of the accessed data by the accessing network user; and
determining an adjusted point value dependent at least in part upon said rating step.

9. The method of claim 8, wherein said access step further comprises decreasing said second number of points by a rating amount.

10. The method of claim 9, wherein said access step further comprises increasing said second number of points by said rating amount when said accessing user completes said rating step.

11. The method of claim 4, said second computer having a second number of points, wherein said access step comprises:
comparing said second number of points to an access sum, said access sum comprising the sum of said point value of the data be accessed and a rating amount;
denying access to the data when said second number of points is less than said access sum; and
granting access to the data when said second number of points is at least equal to said access sum.

12. The method according to claim 4, wherein the data comprises at least one of text, graphic, audio, video, multimedia data and software programs.

13. The method according to claim 4, comprising the further step of
providing information to assist a network user in selecting particular data from the data that can be accessed via the network.

14. The method according to claim 13, wherein said providing information step comprises indicating to a network user at least one of a content of the data and said point value of the data.

15. The method according to claim 4, comprising the further steps of
providing request data corresponding to a selection of data which a network user wants to access;
comparing said request data with at least portions of the data that can be accessed in the network; and
returning to the network user at least one of a first list of data for which said comparing step results in at least a partial match with said request data and a second list of data which indicates the data that can be accessed in the network and for which at least a partial match was determined.

16. The method according to claim 15, wherein said providing request data step is effected by means of the second computer system.

17. An apparatus for trading data, comprising:
a central computer system;
at least one data-providing computer system, each of said at least one data-providing computer system having associated data, said associated data having a point value;
a network interconnecting said central computer system and said at least one user computer system, said data being accessible via said network;
central computer system software selectively granting access to said data dependent at least in part upon said point value.
